(19) United States
(12) Patent Application Publication
(10) Pub. No.: US 2026/0177994 A1
(43) Pub. Date: Jun. 25, 2026

(54) SYSTEM AND METHODS FOR DETERMINING USERS INTENT IN ACCESS APPLICATIONS

(71) Applicant: Qorvo US, Inc., Greensboro, NC (US)

(72) Inventors: Ha Cam Thanh Le, Toulouse (FR); Eric Perraud, Plaisance du Touch (FR)

(21) Appl. No.: 19/401,033

(22) Filed: Nov. 25, 2025

Related U.S. Application Data
(60) Provisional application No. 63/737,498, filed on Dec. 20, 2024.

(51) Int. Cl. G05B 13/02

(52) U.S. Cl. CPC G05B 13/027

(57) ABSTRACT

A method for controlling an object based on a user's intent is provided. The method includes: receiving an ultra-wideband (UWB) frame from a UWB device; generating an input vector based on the UWB frame; generating, by a deep learning framework, a plurality of intent probabilities conditioned on the input vector; determining the user's intent based on the plurality of intent probabilities; and generating a control signal corresponding to the user's intent.

The present application claims priority to and the benefit of U.S. Provisional Application No. 63/737,498, entitled “SYSTEM AND METHODS FOR DETERMINING USERS INTENT IN ACCESS APPLICATIONS” and filed on Dec. 20, 2024, which is hereby incorporated by reference in its entirety.

### FIELD OF THE DISCLOSURE

The present disclosure relates to ultra-wideband (UWB) enabled devices, and systems for systems and methods for determining user's intent in access applications, in particular, to improve the accuracy in determining user's intent using artificial intelligence (AI) means.

### BACKGROUND

Ultra-wideband (UWB) is a wireless communication technology that transmits data over a wide frequency spectrum. It is designed for short-range, high-bandwidth applications and excels in precise distance measurement and location tracking. UWB can operate within the frequency range of 3.1 GHz to 10.6 GHZ, as defined by the Federal Communications Commission (FCC), and is used in various industries for its unique capabilities. One application for UWB technology is an access system that takes advantage of the high precision in short-range distance measurements of UWB ranging to facilitate secure and efficient entry control. In such an access system, access can be automatically granted to a user based on the user's distance to the entrance.

However, the existing access systems using UWB technology has limitations. For example, entry may be falsely granted or denied based on the result of UWB ranging. Thus, an access system capable of interpreting a user's intent with higher accuracy is desired.

### SUMMARY

Aspects of the present disclosure provide a method for controlling an object based on a user's intent. The method includes receiving an ultra-wideband (UWB) frame from a UWB device; generating an input vector based on the UWB frame; generating, by a deep learning framework, a plurality of intent probabilities conditioned on the input vector; determining the user's intent based on the plurality of intent probabilities; and generating a control signal corresponding to the user's intent.

In some embodiments, the generating of the input vector includes generating a first input vector and a second input vector, each corresponding to a different type of UWB data. In some embodiments, the first input vector and the second input vector include UWB parameters measured at a same rate during a same period of time.

In some embodiments, the generating, by the deep learning framework, the plurality of intent probabilities conditioned on the input vector includes: generating, by the deep learning framework, a first feature vector from the first input vector and a second feature vector from the second input vector; performing, by the deep learning framework, a feature fusion operation to generate a concatenated feature vector combining the first feature vector and the second feature vector; and generating, by the deep learning framework, the plurality of intent probabilities based on the concatenated feature vector.

In some embodiments, the deep learning framework includes a first deep learning model to generate the first feature vector and a second deep learning model to generate the second feature vector; and the deep learning framework includes a fully connected layer and a SoftMax layer to generate the plurality of intent probabilities from the concatenated feature vector.

In some embodiments, the determining of the user's intent includes comparing the plurality of intent probabilities to a threshold value; in response to a highest one of the intent probabilities being higher than or equal to the threshold, determining the user's intent to be a predetermined classification; and in response to the highest one of the intent probabilities being lower than the threshold, determining the user's intent to be “unknown.”

In some embodiments, the generating of the first input vector includes: determining a plurality of channel impulse response (CIR) estimates based on the UWB frame that is transmitted by a UWB radar and reflected by the user and a surrounding environment; selecting a plurality of taps from each of the plurality of CIR estimates; and generating a CIR vector based on the plurality of CIR estimates and the plurality of taps corresponding to each of the plurality of CIR estimates.

In some embodiments, the method further includes dividing the CIR vector into a first CIR vector and a second CIR vector, wherein the first CIR vector includes a real component of the CIR vector and the second CIR vector includes an imaginary component of the CIR vector.

In some embodiments, the method further includes applying a pre-processing algorithm on the first CIR vector or the second CIR vector, wherein the pre-processing algorithm includes a Clutter Cancellation algorithm, a constant false alarm rate (CFAR) filtering algorithm, or an Image Reshape algorithm.

In some embodiments, the deep learning framework includes a convolutional neural network (CNN), gated recurrent units (GRUs), or long short-term memory (LSTM) cells, or a fully connected (FC) layer to generate the first feature vector.

In some embodiments, the method further includes initiating a two-way ranging (TWR) with the UWB device, and wherein the generating of the second input vector further includes: measuring a plurality of UWB values from a plurality of ranging rounds in the TWR; and generating the second input vector comprising the plurality of consecutive UWB values.

In some embodiments, in response to a measuring of a UWB value in a first ranging round being unsuccessful, replacing the UWB value in the input vector with a UWB value that is successfully measured in a second ranging round that is most recent to the first ranging round.

In some embodiments, the generating of the second input vector includes generating a distance vector comprising a plurality of distance estimates computed from the plurality of ranging rounds.

In some embodiments, the generating of the second input vector includes generating a set of phase difference of arrival (PDOA) vectors computed from the plurality of ranging rounds, the sets of the PDOA vectors comprising a plurality of PDOA estimates computed from each of the ranging rounds.

In some embodiments, the generating of the second input vector further includes generating a received signal strength indicator (RSSI) vector comprising a plurality of RSSI estimates computed from the plurality of ranging rounds.

In some embodiments, the deep learning framework includes gated recurrent units (GRUs) to generate the second feature vector.

Aspects of the present disclosure provide an ultra-wideband (UWB) device with a UWB receiver. The UWB device is configured to: receive an ultra-wideband (UWB) frame from a UWB device; generate an input vector based on the UWB frame; generate, by a deep learning framework, a plurality of intent probabilities conditioned on the input vector; determine the user's intent based on the plurality of intent probabilities; and generate a control signal corresponding to a user's intent.

In some embodiments, to generate the input vector includes generating a first input vector and a second input vector, each corresponding to a different type of UWB data; and the first input vector and the second input vector include UWB parameters measured at a same rate during a same period of time.

In some embodiments, to generate, by the deep learning framework, the plurality of intent probabilities conditioned on the input vector includes: generating, by the deep learning framework, a first feature vector from the first input vector and a second feature vector from the second input vector; performing, by the deep learning framework, a feature fusion operation to generate a concatenated feature vector combining the first feature vector and the second feature vector; and generating, by the deep learning framework, the plurality of intent probabilities based on the concatenated feature vector.

In some embodiments, the deep learning framework includes a first deep learning model to generate the first feature vector and a second deep learning model to generate the second feature vector; and the deep learning framework includes a fully connected layer and a SoftMax layer to generate the plurality of intent probabilities from the concatenated feature vector.

In some embodiments, to determine the user's intent includes comparing the plurality of intent probabilities to a threshold value; in response to a highest one of the intent probabilities being higher than or equal to the threshold, determining the user's intent to be a predetermined classification; and in response to the highest one of the intent probabilities being lower than the threshold, determining the user's intent to be “unknown.”

Aspects of the present disclosure provide a non-transitory computer-readable medium (CRM) having program code recorded thereon. The program code includes: code for receiving an ultra-wideband (UWB) frame from a UWB device; code for generating an input vector based on the UWB frame; code for generating, by a deep learning framework, a plurality of intent probabilities conditioned on the input vector; code for determining the user's intent based on the plurality of intent probabilities; and code for generating a control signal corresponding to a user's intent.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description, serve to explain the principles of the disclosure.

FIGS. 1A and 1B illustrate an exemplary operation environment of an access system, according to some aspects of the present disclosure.

FIG. 1C shows certain parameters used by the access system, according to some aspects of the present disclosure.

FIG. 2A illustrates a simplified block diagram of an exemplary access system, according to some aspects of the present disclosure.

FIG. 2B illustrates an exemplary deep learning framework used in the access system, according to some aspects of the present disclosure.

FIG. 3A illustrates an exemplary block diagram of a tag, according to some aspects of the present disclosure.

FIG. 3B illustrates an exemplary block diagram of an anchor, according to some aspects of the present disclosure.

FIG. 4 illustrates an exemplary method for determining a user's intent, according to some aspects of the present disclosure.

FIGS. 5A-5D show examples of certain Channel Impulse Response (CIR) matrices, according to some aspects of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein. Additionally, like reference numerals denote like features throughout specification and drawings.

It should be appreciated that the blocks in each signaling diagram or flowchart and combinations of the signaling diagrams or flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each signaling diagram or flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction for performing the functions described in connection with a block(s) in each signaling diagram or flowchart. Since the computer program instructions may be equipped in a computer or other programmable data processing devices, instructions that generate a process executed by a computer as a series of operational steps are performed by the computer or other programmable data processing devices and operate the computer or other programmable data processing devices may provide steps for executing the functions described in connection with a block(s) in each signaling diagram or flowchart.

Each block may represent a module, segment, or part of a code including one or more executable instructions for executing a specified logical function(s). Further, it should also be noted that in some replacement execution examples, the functions mentioned in the blocks may occur in different orders. For example, two blocks that are consecutively shown may be performed substantially simultaneously or in a reverse order depending on corresponding functions.

Hereinafter, embodiments are described in detail with reference to the accompanying drawings. Further, although a communication system using ultra-wideband (UWB) is described in connection with embodiments, as an example, the embodiments may also apply to other communication systems with similar technical background or features. For example, a communication system using Bluetooth or ZigBee may be included therein. Further, embodiments may be modified in such a range as not to significantly depart from the scope of the present disclosure under the determination by one of ordinary skill in the art and such modifications may be applicable to other communication systems.

UWB may refer to a short-range high-rate wireless communication technology using a wide frequency band of several hundreds of MHz to several GHz or more, low spectral density, and short pulse width (e.g., 1 nsec to 4 nsec) in a baseband state. UWB may mean a band itself to which UWB communication is applied. UWB may enable secure and accurate ranging between devices. Thus, UWB enables relative position estimation based on the distance between two devices or accurate position estimation of a device based on the distance from fixed devices (whose positions are known, also referred to as anchors or anchor devices). The present disclosure assumes that the user is carrying a device capable of communicating through UWB (referred to as “UWB-enabled user device” or simply user device).

Existing access systems (of home, car, building . . . ) often use UWB ranging to accurately and securely measure the proximity of the user in order to lock or unlock an entrance. For example, when the user is in the predetermined security perimeter, the entrance is unlocked. However, in many circumstances, the user may simply pass by in front of the entrance, and/or cross a security perimeter around the entrance although they do not intend to exit/enter. In another example, the user may cross the security perimeter and indeed intends to enter the entrance. Accordingly, the access system is configured to not unlock the entrance in the first example, and unlock the entrance in the second example.

It means that the criteria for the access system to determine locking or unlocking the entrance should not rely only on ranging measurements. It is desired that the access system can more intelligently determine the user's intent. The proposed solution in this disclosure includes a framework (e.g., an algorithm) configured to detect the user's intent: enter, leave, or pass by. In this disclosure, intents “enter” and “leave” may both refer to a user moving through an object (e.g., entrance) but with opposite directions. For example, “enter” may refer to a user moving from point A to point B through the object, and “leave” may refer to a user moving from point B to point A through the object. “Pass by” may refer to a user moving into a predetermined security perimeter but not moving through the entrance.

Embodiments of the present disclosure provide a system and a method to more accurately detect a user's intent using UWB data when the user is in the proximity of an entrance, of which the locking/unlocking is controlled by the access system. The access system may include an anchor installed sufficiently close to the entrance and a tag (e.g., a user device) carried by a user. The user's movement can be detected by the access system through the anchor. The access system may include a deep learning framework/algorithm configured to determine the user's intent based on UWB data detected by the anchor. The access system can thus intelligently control the locking/unlocking of the entrance based on the detection/recognition of the user's intent: enter, leave, or pass by. For example, when the user intends to enter the entrance, the access system may detect this intent with a very high probability and a high confidence, so that the entrance is unlocked only when an authorized user intends to enter, as early as possible to avoid the Wall effect.

The access system may be built with a deep learning framework (e.g., a deep-learning-based classification algorithm) for detecting the three intents/classes: enter, leave, and pass by. The access system may assess the confidence level of the classification. The probability of each intent/class may be given as the output of the deep learning framework. Based on a predetermined threshold, the access system may accept the classification result only if the highest probability among three classes is higher than the predetermined threshold. If the probability of each class is below the predetermined threshold, the access system may return an “unknown” classification, e.g., determine the user's intent as “unknown” and maintain the current status (e.g., locking/unlocking) of the entrance.

Based on the result of the intent detection, the access system may determine the decision of locking or unlocking the entrance. For example, when the access system detects the user's intent as “enter” with a high confidence level (above the predetermined threshold), the entrance may be then unlocked. In another example, when the access system detects that the user's intent as “leave” with a high confidence level, it locks the entrance. In another example, when the user just passes by the entrance or the confidence level of the intent is not determined to be sufficiently high (“unknown”), the access system may make no decision on the entrance. In some embodiments, other criteria may also be considered by the access system to determine its action on the entrance. In this disclosure, an inference may refer to the detection/determination of a user's intent (e.g., enter, leave, pass by, or unknown). In some embodiments, to increase the reliability of the detection and avoid “false alarms”, multiple inferences may be used to generate a control signal for a corresponding operation. For example, instead of indicating an “enter” intent with only one inference, 3 consecutive inferences detecting an “enter” intent may be required to unlock the entrance. For example, the access system may receive X among Y (Y>=X) consecutive identical inferences which indicate the user's intent as “enter,” and may unlock the entrance.

By utilizing the deep learning framework, the disclosed access system may detect a user's intent of “enter” with a success rate of about 95% and a confidence level better than about 80% for a single inference. A pass by trajectory may not be interpreted as an “enter” user's intent that may unlock the door. In some embodiments, when the user's starts an enter trajectory at about A m away from the door, the algorithm detects the user's intent of “enter” at B m, where A is greater than B.

It should be noted that, the disclosed method may also be applied in other suitable smart systems/applications to control the operations of certain objects. For example, an access system with the disclosed intent determining function may control the locking/unlocking of a vehicle, etc. UWB radar signals, measured distances, RSSI's and/or phase difference of arrival (PDOA) in a UWB two-way ranging (TWR) can be used to form input for the deep-learning model to determine the user's intent.

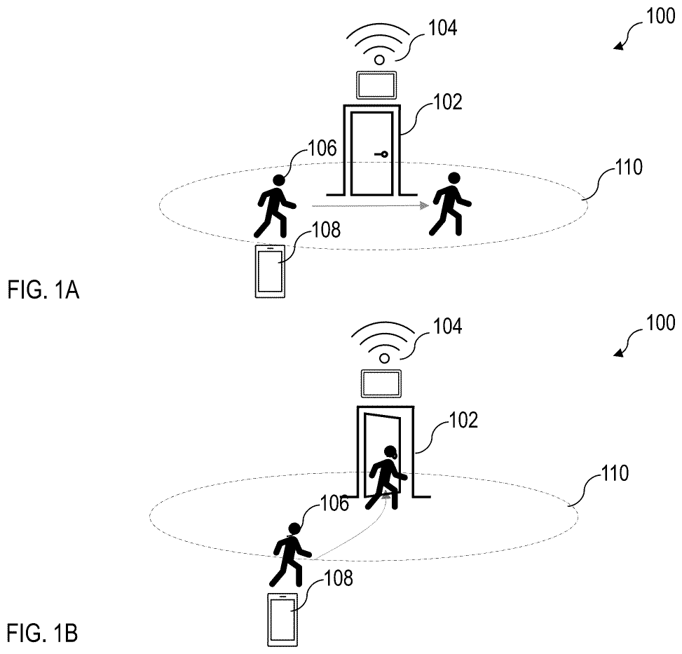

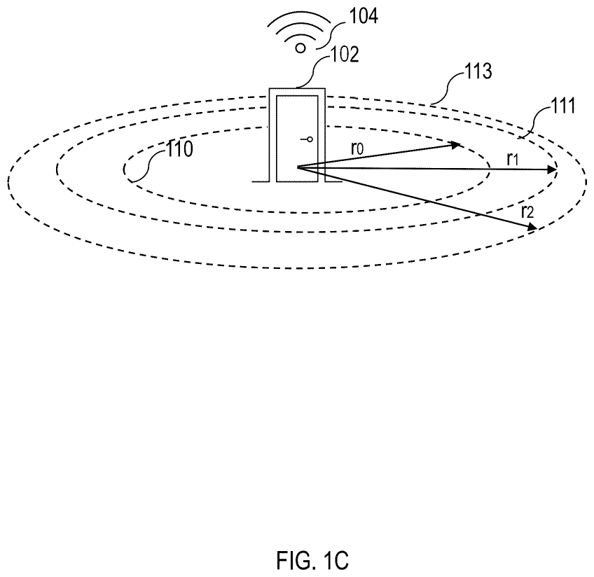

FIGS. 1A and 1B show an operation environment for an access system 100, according to some embodiments. Access system 100 may include a controller and a controlee, which listens to and performs ranging with the controller. In some embodiments, the controller includes at least one anchor installed near an entrance 102 (or any suitable object of which the operation is controlled by access system 100). For ease of illustration, the at least one anchor is represented by an anchor 104 installed sufficiently close to entrance 102, e.g., above entrance 102. In various embodiments, anchor 104 and entrance 102 may be considered to be located at the same location, or the location of each of them can be determined based on the location of the other. For example, the conversion between the locations of anchor 104 and entrance 102 may be preconfigured in access system 100. Anchor 104 may be configured for UWB communication and other out-of-band (OOB) communication means. In some embodiments, access system 100 may also include other infrastructure elements, such as a network control device, and/or a cloud network that are communicatively coupled to anchor 104 to facilitate data processing and computation. A user 106 may carry a user device 108 moving in the proximity of entrance 102. User device 108 may function as the controlee, and may include a UWB device with the capability of UWB communication and/or other OOB communication means with anchor 104.

Access system 100 may be pre-configured with a security perimeter 110, which may be represented by a predetermined distance range originated from entrance 102. For example, access system 100 may determine the operation of entrance 102 when user 106 is in security perimeter 110. Access system 100 may control the “locking” and “unlocking” of entrance 102 based on the determined intent of user 106. Access system 100 may determine the intent of user 106 based on the UWB communication between user device 108 and anchor 104. For example, as shown in FIGS. 1A and 1B, access system 100 keeps entrance 102 locked when determining that user 106's intent is pass by (FIG. 1A), and unlocks entrance 102 when determining that user 106's intent is “enter.” In various embodiments, access system 100 can be implemented in systems with app-based control hardware such as Google Home, Apple Home, Amazon Alexa, etc.

FIG. 1C shows certain distance ranges used in the determining of a user's intent, according to some embodiments. Access system 100 may be preconfigured security perimeter 110, a start-intent perimeter 111, and a start-measure perimeter 113. Start-intent perimeter 111 may be larger than security perimeter 110 such that a distance (e.g., r1) from start-intent perimeter 111 to entrance 102 is greater than a distance (e.g., r0) from security perimeter 110 to entrance 102. Start-measure perimeter 113 may be larger than start-intent perimeter 111 such that a distance (e.g., r2) from start-measure perimeter 113 to entrance 102 is greater than a distance (e.g., r1) from start-intent perimeter 111 to entrance 102. In some embodiments, anchor 104 monitors the location of user device 108 outside of start-measure perimeter 113 using out-of-band (OOB) means such as WiFi and/or Bluetooth. Each perimeter may have any desirable shapes, e.g., based on the setting of access system 100, and should not be limited by the embodiments of the present disclosure.

Access system 100 may start measuring certain UWB parameters when the distance between user device 108 and entrance 102 (or anchor 104) is equal to or less than r2 and greater than r1. In some embodiments, access system 100 may start computing certain UWB parameters such as CIR estimates of UWB radar echo, distances between user device 108 and anchor 104, optionally PDOA values of user device 108 relative to anchor 104, and optionally RSSI values of user device 108. In some embodiments, anchor 104 initiates TWR with user device 108, and may compute the UWB parameters based on the UWB frames received in the TWR. Then, access system 100 may start determining the user's intent when the distance between user device 108 and entrance 102 (or anchor 104) is equal to or less than r1. In some embodiments, access system 100 may start generating inputs for a deep learning framework (details described as follows) based on the UWB parameters. Depending on the design, access system 100 may or may not pre-process the inputs before feeding them to the deep learning framework. Access system 100 may determine the user's intent based on intent probabilities outputted by the deep learning framework.

When the distance between user device 108 and entrance 102 (or anchor 104) is equal to or less than r0, access system 100 may determine to lock or unlock entrance 102 based on the determined user's intent. For example, if user device 108 (or user 106) is in security perimeter 110 (e.g., the distance between user device 108 and anchor 104 is equal to or less than r0) and the user's intent is determined to be “enter” or “leave,” access system 100 may control to unlock entrance 102. If user device 108 (or user 106) is in security perimeter 110 and the user's intent is determined to be “pass by,” access system 100 may maintain the current status of entrance 102. If access system 100 fails to determine the user's intent from the UWB parameters or determines the user's intent to be “unknown,” access system 100 may control to maintain the current status (locking/unlocking) of entrance 102.

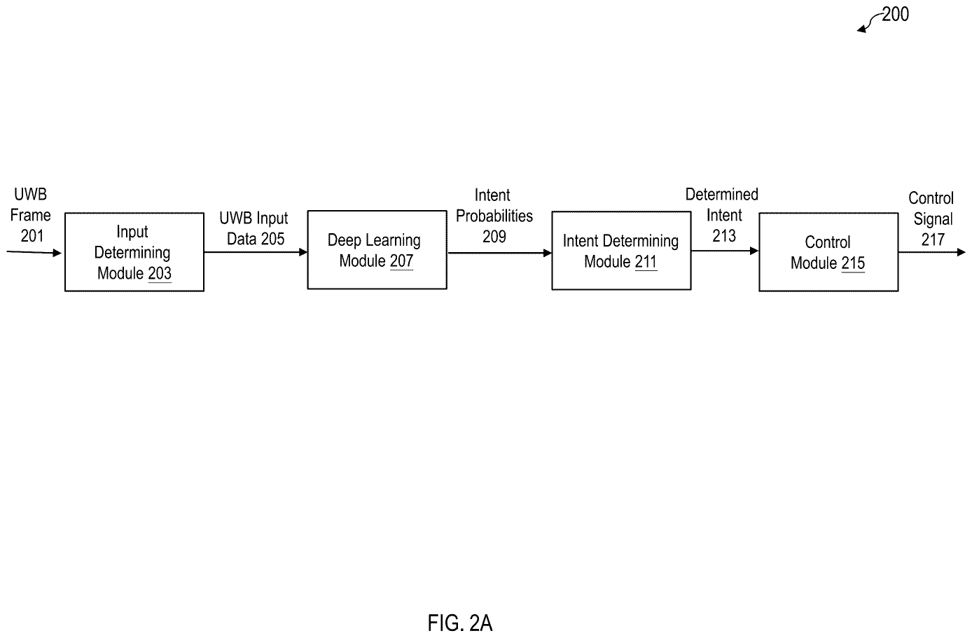

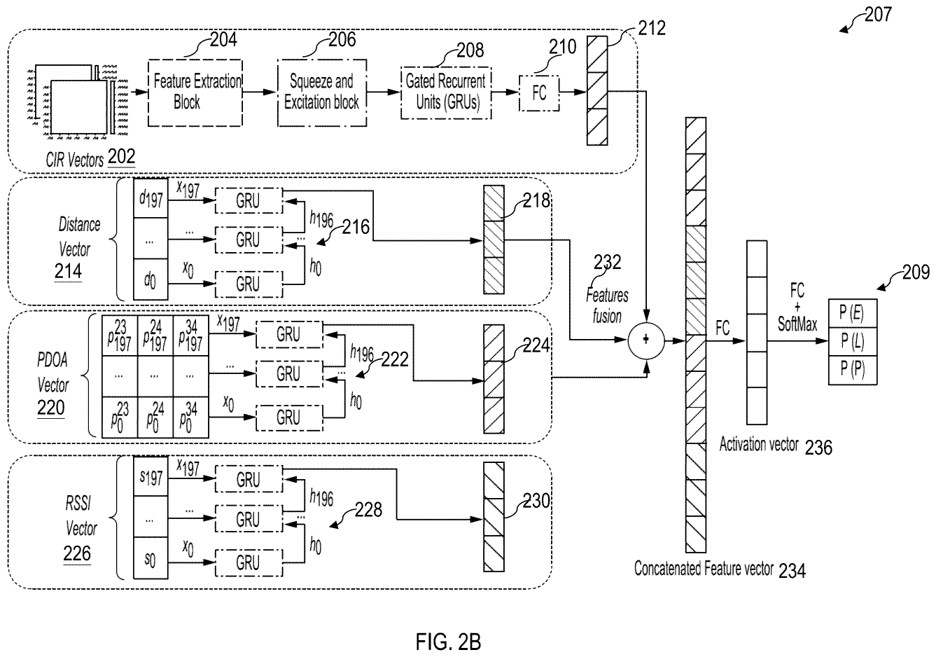

FIG. 2A shows a simplified block diagram of access system 200, according to some embodiments of the present disclosure. Access system 200 may be an example of access system 100. Access system 200 may be implemented in an anchor, and/or other part of the infrastructure with computing capabilities, such as a network control device, a cloud network, etc. Access system 200 may include an input determining module 203, a deep learning module 207, an intent determining module 211, and a control module 215. Modules 203, 207, 211, and 215 may be configured to control an object (e.g., lock/unlock an entrance) based on a user's intent. In some embodiments, modules 203, 207, 211, and 215 may each include suitable software and/or hardware to perform specific functions. In some embodiments, the functions of modules 203, 207, 211, and 215 are performed by specific data-processing circuits and/or processors.

In the present disclosure, more than one types of UWB data are used to determine the user's intent. The types of UWB data may include UWB radar/receiver channel impulse response (CIR) data, two-way ranging (TWR) distance data, TWR phase difference of arrival (PDOA) data, and/or received signal strength indicator (RSSI) data. UWB Radar/receiver CIR data may reflect the interaction between a UWB signal (transmitted from the user device) and the environment, TWR distance data may reflect the distance from the user device to the entrance, TWR PDOA data may reflect the relative position of the user device to the entrance, and the RSSI data may quantify the received power of a UWB signal (at the entrance) from the user device. The different types of UWB data may be used as different inputs for a deep learning framework, and may each be processed by a deep learning model independently. The extracted features may then be fused together to deliver a more reliable classification and associated confidence level. Prior to the runtime/inference, the deep learning models have been trained to characterize the 3 classes of user's intent: enter, leave, and pass by, respectively.

Input determining module 203 may be configured to receive UWB data, e.g., a UWB frame 201, (e.g., “raw” UWB data) and pre-process the received UWB data to generate UWB input data 205 for deep learning module 207. For example, input determining module 203 may include a UWB receiver which may include an antenna, an analog radio frequency (RF) and baseband (BB) circuit, an I (In-phase)/Q (Quadrature-phase) sampling circuit, a correlator, a carrier frequency offset (CFO) remover circuit, and an accumulator. In some embodiments, an anchor of access system 200 may perform UWB communication with a user device (e.g., 108) to receive UWB frame 201, and may generate UWB input data 205 based on UWB frame 201.

In some embodiments, the anchor may initiate two-way ranging (TWR) with the user device, e.g., when the user (e.g., 106) enters the pre-configured start-measurement perimeter (e.g., 113). This TWR may allow the anchor to measure the distance from the user. The anchor may also include RSSI measurements and/or PDOA measurements which are synchronized with the measured distance. RSSI and/or PDOA are measured by the anchor with the received UWB frames of the UWB ranging round, e.g., the ranging response message and the ranging result report messages. When the user enters in the start-intent area, the UWB transmitter of the anchor sends UWB frames. The UWB receiver of the anchor may receive UWB frames which are reflected by the user device (e.g., 108) and determine channel impulse response (CIR) estimates at given times, e.g., by accumulating the deterministic sequences (e.g., Ipatov sequences) in the UWB frames. A CIR estimate may reflect the interaction between a UWB signal and the user.

In some embodiments, access system 200 may include a UWB receiver/radar and a UWB TWR controller running at the same rate (e.g., 10 milliseconds/ms). The UWB receiver/radar and the UWB TWR controller control the discrete data points in the inputs to be generated at the same rate. In some embodiments, the radar received CIR estimate is collected by input determining module 203 at a predetermined rate (e.g., every 10 ms). During a predetermined period of time such as a 2 second duration, N vectors each containing M taps associating to N CIR estimates can be accumulated, N being greater than M. In an example, N is equal to 198, and M is equal to 64. For example, input determining module 203 may determine/compute N consecutive CIR estimates in the 2 second duration, and select M taps for each CIR estimate. A two dimensional (2D)-array/vector/image x[n, k], reduced to the fixed size (N,M), can be formed. Slow-time (k) represents the received CIR index, and fast-time (n) represents the tap index. In other words, at a 2 second duration (or every 2 seconds), a N×M matrix/array, representing the M taps in the N CIR estimates, may be formed.

Because a CIR estimate is a complex value and may include an I component (real part) and a Q component (imaginary part), the N×M matrix may be a complex matrix with the taps being complex numbers. In some embodiments, the N×M matrix may be divided into two N×M matrices (or two images), with one including the real parts of the taps, and the other including the imaginary parts of the taps. In some embodiments, at a 2 second duration (e.g., every 2 seconds), two N×M CIR matrices, respectively representing the real part and the imaginary part of the CIR estimates, are formed as CIR input vectors for deep learning module 207.

Meanwhile, TWR may be performed between the anchor and the user device. The anchor may compute TWR data (e.g., estimated distances and/or PDOA values) based on the computed TOF in the predetermined period of time, such as 2 seconds, and may use the distances and PDOA values to allow an authorized user to enter, and avoid an unauthorized user to enter. In some embodiments, input determining module 203 may compute the estimated distances and the estimated PDOA values at the same rate (e.g., at a predetermined rate such as every 10 ms) as done with the UWB radar/receiver. In some embodiments, N estimated distances are collected for the 2 second period, and is used to form a (N, 1) distance vector, which is used as an input to deep learning module 207. In some embodiments, at least one PDOA value is estimated every 10 ms and N PDOA values are computed for the 2 seconds duration. In some embodiments, more than 1 PDOA value, such as 3, is computed every 10 ms to cover the 360 degrees range. For example, a (N, 3) PDOA vector may be formed for the 2 second duration, and is used as an input to deep learning module 207.

Therefore, at a predetermined rate (e.g., every 10 ms), input determining module 203 may generate two (N,M) CIR matrices, one (N,1) distance vector, one (N,3) PDOA vector, and one (N, 1) RSSI vector, for deep learning module 207 to determine a classification. In various embodiments, the classification may be determined at any desired rate, depending on the design and/or the capability of access system 100. For example, in inference, the classification may be done at a slower rate, such as every 100 ms.

In some embodiments, the distance(s) may also be used to identify the user in the CIR matrices and filter out the taps of echoes of undesired users. For example, by knowing the distance of the authorized user, the algorithm can identify the taps of interest and filters the taps of undesired/unauthorized users.

In the TWR, input determining module 203 may consistently measure the signal intensity of the UWB signal received from the user device in the predetermined period of time, e.g., 2 seconds. In some embodiments, the anchor may measure the signal intensity at the same predetermined rate as the distance/PDOA measurement, e.g., at every 10 ms. Input determining module 203 may then generate a (N,1) RSSI vector for the predetermined period of time of 2 seconds, as an input for deep learning module 207.

In some embodiments, input determining module 203 may pre-processes the input matrices/vectors to before feeding them to deep learning module 207. The pre-processing may reduce the computation burden for access system 200, and/or resulting in outputs of improved accuracy.

In some embodiments, the pre-processing of radar/receiver CIR matrices (e.g., the two (N, M) matrices or images) may include one or more techniques such as clutter cancellation, constant false alarm rate (CFAR) filter, and/or image reshape.

In some embodiments, clutter cancellation is applied on at least one of the two CIR matrices to remove the stationary clutter by employing the moving average value or exponential moving average value along slow time. For a given matrix, a value in this matrix is suppressed by an average value of its column as shown in equation (1):

$$x [ i , j ] = x [ i , j ] - \frac{1}{n} {\sum }_{u ∈ n} x [ u , k ] \qquad ( 1 )$$

In some embodiments, CFAR filter is applied on at least one of the two CIR matrices to detect targets amidst noise. Target detection involves the comparison between a threshold and the UWB signal. The CFAR filter estimates the noise level by analyzing a set of training cells adjacent to the cell under test. This is done by using the mean of training cells, denoted as σₙₒᵢₛₑ. The detection threshold γ is then flexibly calculated by σₙₒᵢₛₑ. K, where K is chosen to achieve a specific false alarm rate. If the signal in the cell under test exceeds this threshold, it is considered a potential target. If not, this cell is set to 0.

In some embodiments, image reshape is applied on at least one of the two CIR matrices. For example, the number of columns is reduced to K (e.g., 32 for a matrix of 64 columns) from the I^{th} (e.g., 7^{th}) pulse to the J^{th} (e.g., 38^{th}) pulse, J and I being both less than K, J being greater than I. Consequently, the CIR matrices may now each have a shape of (N, J−I+1). In some embodiments, the image reshape/reduction may reduce the complexity of deep learning module 207 (or the deep learning framework).

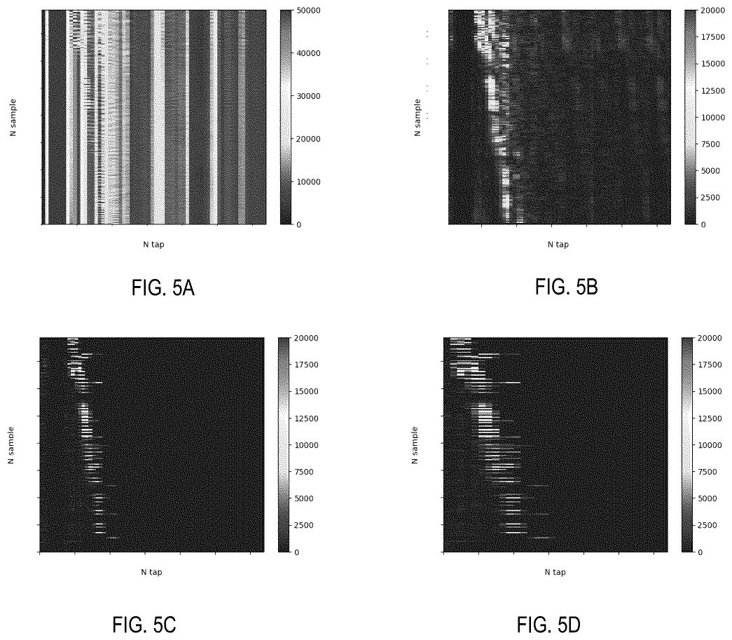

As an example, the results after each method of pre-processing are presented in FIGS. 5A-5D. FIG. 5A shows a “raw” CIR matrix (before any pre-processing). FIG. 5B shows the clutter-removed CIR matrix from FIG. 5A using clutter cancellation. FIG. 5C shows the CFAR-filtered CIR matrix from FIG. 5A using CFAR filter. FIG. 5D shows a reshaped CIR matrix from FIG. 5A using image reshape. It can be shown that the date pre-processing can transform raw data into a matrix/an image representing the movement of a user (or user device), and can improve the feature extraction by deep learning module 207. The example is the case of an enter intent.

In some embodiments, the distance vector and the PDOA vectors may also undergo pre-processing. In some embodiments, if a ranging round in TWR is unsuccessful, the value of distance and/or PDOA values in the unsuccessful ranging round are replaced by the distance and/or PDOA value of the most recent (e.g., latest) successful ranging round to maintain the structure (e.g., number of distances and/or PDOA values) of the vector. For example, a (N, 1) distance vector may include distances measured from N consecutive ranging rounds during the predetermined period of time of 2 seconds. In order not to lose the structure of N consecutives measured distances, certain distances value may be reused. For example, the distances measured from ranging round 0 to ranging round k may be successful, but the distance measured from ranging round (k+1) may be unsuccessful, so the distance corresponding to ranging round (k+1) in the distance vector may be equal to the distance measured from ranging round k. Similarly, in some embodiments, unsuccessful PDOA values measured from an unsuccessful ranging round are replaced with the PDOA of the most recent successful ranging round. In other embodiments, the missed or unsuccessfully measured distances and/or PDOA can be replaced by interpolated values from previous successful measurements.

In some embodiments, PDOA values may undergo an “unwrapping” pre-processing step to ensure all the PDOA values are in the period [−π, π].

As described above, UWB input data 205 may include a pair of CIR matrices, a distance vector, a PDOA vector or a matrix of 2 or 3 PDOAs per measurement, and a RSSI vector, at a given time, as the inputs to deep learning module 207. In various embodiments, the inputs may or may not undergo a pre-processing step. As shown in FIG. 2B, deep learning module 207 may output intent probabilities 209 (e.g., probability distribution for each of the three intents/classes: enter, leave, and pass by, conditioned on the inputs) to intent determining module 211. Intent determining module 211 may then compare the highest one of the intent probabilities to a predetermined threshold and output a determined intent 213. If the highest probability is equal to or higher than the threshold, determined intent 213 may be the highest probability. If the highest probability is lower than the threshold (e.g., all three probabilities are lower than the predetermined threshold), determined intent 213 may be “unknown”.

Control module 215 may generate a control signal 217 corresponding to determined intent 213. For example, control signal 217 may be configured to unlock an entrance (e.g., 102) if determined intent 213 includes “enter” or “leave,” lock the entrance if determined intent 213 includes “pass by,” and maintain the status (e.g., locking/unlocking) of the entrance if determined intent 213 includes “unknown.”

FIG. 2B shows deep learning module 207 generating intent probabilities 209 given inputs, according to some embodiments. In some embodiments, deep learning module 207 includes a deep learning framework, e.g., a neural network model, which may include a plurality of deep learning models each corresponding to a different input. At a given time, UWB input data 205 to deep learning module 207 may include a pair of CIR matrices 202, a distance vector 214, a PDOA vector 220, and/or a RSSI vector 226. As previously described, CIR matrices 202, distance vector 214, and PDOA vector 220 may or may not undergo pre-processing.

In some embodiments, as described above, CIR matrices 202 may include matrices of 2 channels, e.g., one for the real part of the CIR estimates and the other for the imaginary part of the CIR estimates. To extract meaningful features of the CIR matrices, the deep learning model for CIR matrices may include a feature extractor block 204. Feature extraction block 204 may include a convolutional neural network (CNN). In some embodiments, a series of CNN blocks followed by a parametric rectified linear unit (PreLU) activation function are included in feature extraction block 204. The deep learning model may also include a squeeze and excitation block 206 employed following feature extraction block 204, and may enhance the representational capacity of a CNN by adaptively recalibrating channel-wise features. Squeeze and excitation block 206 may ensure that the most informative features are emphasized while less relevant ones are suppressed. By applying a squeeze operation to aggregate global feature information and an excitation operation to adjust channel weights, squeeze and excitation block 206 may improve model performance.

In some embodiments, CIR matrices 202 may include a series of consecutive CIR estimates, which may potentially have some temporal relations/connections. Hence, the deep learning model may include gated recurrent units (GRUs) 208 to learn the temporal features from output of squeeze and excitation block 206, which is then passed through fully connected layers (FC) 210 prior to the fusion step. The output of FC 210 may include a first feature vector 212 including features extracted from CIR matrices 202. In another embodiment, GRUs can be replaced by any cell of deep learning technique designed to find temporal relationship in a time series of samples (like long short-term memory cells or LSTM cells).

Distance vector 214 (d₀, . . . , d_{N-1}), PDOA vector 220 (p₀^{ab}, p₀^{ac}, p₀^{be}; . . . , p_{N-1}^{ab}, p_{N-1}^{ac}, p_{N-1}^{bc}), and/or RSSI vector 220 (s₀, . . . , s_{N-1}) may each include a time series of discrete data collected over time (e.g., in 2 seconds). As an example, PDOA vector 220 includes three columns, each column represents N consecutive measurements performed between two antennas as denoted in the superscripts of each column element (e.g., between antennas a and b, a and c, and b and c). The deep learning model for each of vectors 214, 220, and 226 may include GRUs to handle sequences of data, and identify temporal dependencies and patterns. Applying GRUs on vectors 214, 220, and 226 may help to learn and maintain long-term dependencies in the distances, PDOA values, and/or RSSI values over time. The GRUs can dynamically adjust their memory and update gates to selectively remember or forget information, making it flexible for capturing various meaningful temporal patterns in the input. In the disclosed access system, three separate GRUs are used: GRUs 216 for distance vector 214, GRUs 222 for PDOA vector 220, and GRUs 228 for RSSI vector 226. The output of GRUs 216 may include a second feature vector 218 including features extracted from distance vector 214; the output of GRUs 222 may include a third feature vector 224 including features extracted from PDOA vector 220, and the output of GRUs 228 may include a fourth feature vector 230 including features extracted from RSSI vector 226.

As shown in FIG. 2B, after feature extraction, feature fusion 232 may be performed by concatenating feature vectors 212, 218, 224, and 230 to combine the features extracted based on different inputs (e.g., CIR matrices 202, distance vector 214, PDOA vector 220, and RSSI vector) 226, to generate a concatenated feature vector 234, which is a richer, more comprehensive representation of the user's intent. Features extracted from the CIR matrices 202, distance vector 214, PDOA vector 220, and/or RSSI vector 226 can be integrated into single concatenated feature vector 234. Concatenated feature vector 234 may allow access system 200 to capture a broader range of patterns and relationships that may not be apparent when examining each input in isolation.

Concatenated feature vector 234 may then be passed through one or more fully connected layers (FCs) because they are effective for classification tasks. An activation vector 236 may be generated as an output of the FCs. In some embodiments, the last layer of FCs may include a SoftMax layer. This layer may apply a SoftMax function to the output from the last FC layer. The SoftMax function may convert the output values (e.g., activation vector 236) from the last FC layer to normalized values in the range [0,1], which can be interpreted as a probability score for each class/intent (e.g., enter, leave, and pass by). For example, the input of a SoftMax function may include a vector z=(z₁, . . . , z_{K}), where K is equal to 3 (corresponding to the three intents: “enter,” “leave,” and “pass by”). The SoftMax function may compute each component of vector σ(z)∈[0,1]^{K} with

$${σ ( z )}_{i} = \frac{{e}^{{z}_{i}}}{{\sum }_{j}^{K} {e}^{{z}_{i}}} .$$

The output of the SoftMax function may include a probability vector σ(z) that includes intent probabilities 209: P(E) for intent of enter, P(L) for intent of leave, and P(P) for intent of pass by.

Referring back to FIG. 2A, intent determining module 211 may then apply a probability threshold filter on the probability vector σ(z). Intent determining module 211 may then compare the highest one of intent probabilities 209 to a predetermined threshold. If the highest probability is equal to or higher than the threshold, intent determining module 211 may output the highest probability as determined intent 213. If the highest probability is lower than the threshold (e.g., all three probabilities are lower than the predetermined threshold), intent determining module 211 may output “unknown” as determined intent 213.

In the present disclosure the deep learning framework, including the deep learning models for each input, may be trained prior to inference. In some embodiments, several parameters may be investigated to obtain the best training result. The parameters are described as follows.

Batch size: In the numerical implementation, a batch size of 32 may be used. This means that during the training process, the model will be presented with 32 samples at a time for processing and updating its parameters. Choosing an appropriate batch size is crucial as it balances the computational efficiency and the model's ability to generalize. A batch size of 32 samples is a reasonable trade-off, allowing for efficient parallel processing while providing enough diversity in the mini batches to capture the underlying patterns in the data. A larger batch size can provide faster training but requires more memory, while a smaller batch size may improve generalization but increases the number of iterations needed for convergence.

Number of epochs: (set to be 100) represents the total number of times the model will iterate over the entire training dataset. It affects how extensively the model learns from the data. Too few epochs may result in underfitting, while too many epochs can lead to overfitting, where the model memorizes the training data instead of learning generalizable patterns.

Optimizers: The idea of deep learning is to solve an optimization problem. The optimization algorithm, such as gradient descent variants (e.g., Adam, RMSprop), affects how the model's parameters are updated during training. Each algorithm has its own hyperparameters (e.g., momentum, decay rates) that influence the optimization process. In the implementation, the Adam optimization algorithm may be used to train the deep learning models.

Learning rate (lr): determines the step size taken during gradient descent optimization. It controls how much the model's parameters are updated in each iteration. A high lr can lead to rapid convergence but risks overshooting the optimal solution, while a low lr may result in slow convergence or in getting stuck in suboptimal solutions. Here, the lr of each parameter group is adjusted at each epoch using a cosine annealing schedule. The resetting acts like a simulated restart of learning process and the reuse of good weights as the starting point of the restart. ηₘₐₓ is the initial lr, set to be 5e-4. ηₘᵢₙ is the minimum lr, set to be 0. T_{cur} is the number of epochs since the last restart in Stochastic Gradient Descent. Tₘₐₓ=4000 is the max number of iterations. At the iteration t of optimization process, the lr represented by ηₜ is fine-tuned as the function below in equation (2):

$${η}_{t} = {η}_{min} + \frac{{η}_{max} - {η}_{min}}{2} ( 1 + cos ( \frac{{T}_{cur}}{{T}_{max}} π ) ) \qquad ( 2 )$$

Loss function: In classification tasks, a loss function quantifies the difference between the predicted class probabilities and the true class labels, guiding the optimization process. Common loss functions include the cross-entropy loss, which measures the performance of a classification model by comparing the predicted probability distribution with the true distribution. Mathematically, for C classes, the cross-entropy loss for a single instance is given in equation (3):

$${L}_{entropy} = - {\sum }_{i = 1}^{C} {y}_{i} log ( {p}_{i} ) \qquad ( 3 )$$

Where yᵢ is the binary indicator (1 if class i is the true class and 0 otherwise), represents the true label if class i is correct classification for the instance, and pᵢ is the predicted probability of class i from the model.

For the entire batch of size B, the cross-entropy loss function defined in equation (4):

$${L}_{entropy}^{B} = \frac{1}{B} {\sum }_{n}^{B} {L}_{entropy} \qquad ( 4 )$$

Center loss is also used to enhance feature learning by minimizing the intra-class variation. It is often combined with cross-entropy loss to improve both classification accuracy and feature representation. The center loss function encourages the features of samples from the same class to be closer to the class center. For an activation vector zᵢ and the y^{th} class center μ_{y}_{ᵢ}, the center loss is defined in equation (5):

$${L}_{center} = \frac{1}{2} {\sum }_{i = 1}^{B} {‖ {z}_{i} - {μ}_{{y}_{i}} ‖}^{2} \qquad ( 5 )$$

The class centers are updated during training to minimize the distance between activation vectors and their respective class centers. This helps in enhancing the confidence level as the probability output.

The goal during training is to minimize the combined loss function L=L_{entropy}+λ×L_{center}, thereby improving the model's accuracy in classifying new data.

The impact of linear combination of two loss functions is shown in FIG. 6. λ is chosen to be 0.1

Validation accuracy and the test accuracy have been defined. Validation accuracy means that the prediction is made without considering any confidence threshold. Test accuracy considers this threshold to make a change on the final prediction from the classification results.

It is observed in training that the training loss decreases over time, meaning that the optimization process or training process converges. Around the 10th epoch, the cross-entropy loss converges towards its minimum value; the training accuracy reaches 1, which is the best performance. The validation accuracy remains also approximately 1, meaning that there is no overfitting phenomenon. With the test dataset, probability threshold of 80% is applied as the target confidence level. The test accuracy at this stage is not high and around 40%, although the prediction is still true. However, from the 40th epoch, the center loss decreases significantly, and it helps to better separate the distribution of each class. Consequently, the confidence level of true predictions increases dramatically, and it is even higher than the fixed. In summary, the cross entropy helps to make a good classification, meanwhile the center loss helps to enhance the confidence level of these true classifications.

Evaluation metrics are used. When evaluating a classification model, accuracy is commonly used to assess the performance, as shown in equation (6).

$$Accuracy = \frac{True predictions}{Total predictions} \qquad ( 6 )$$

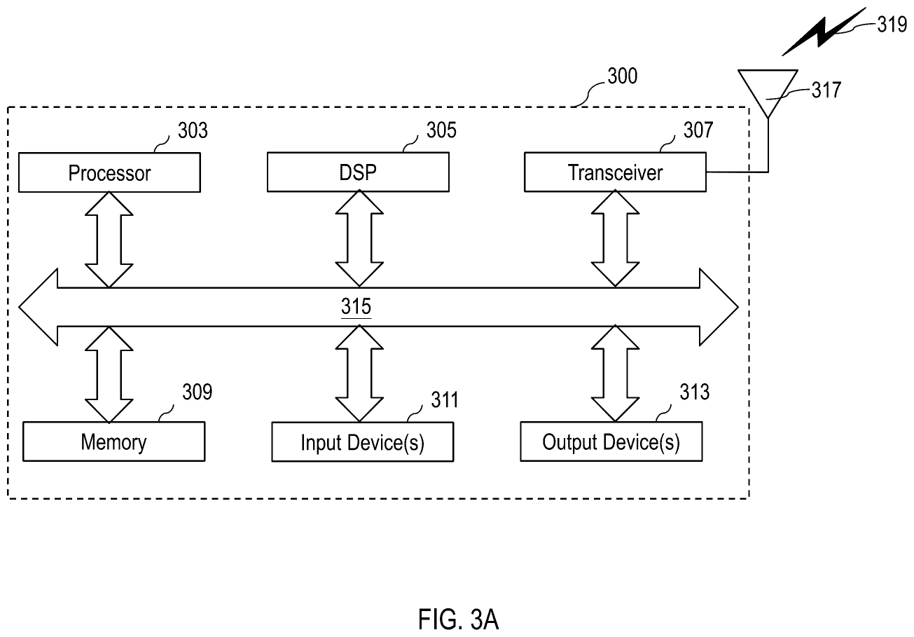

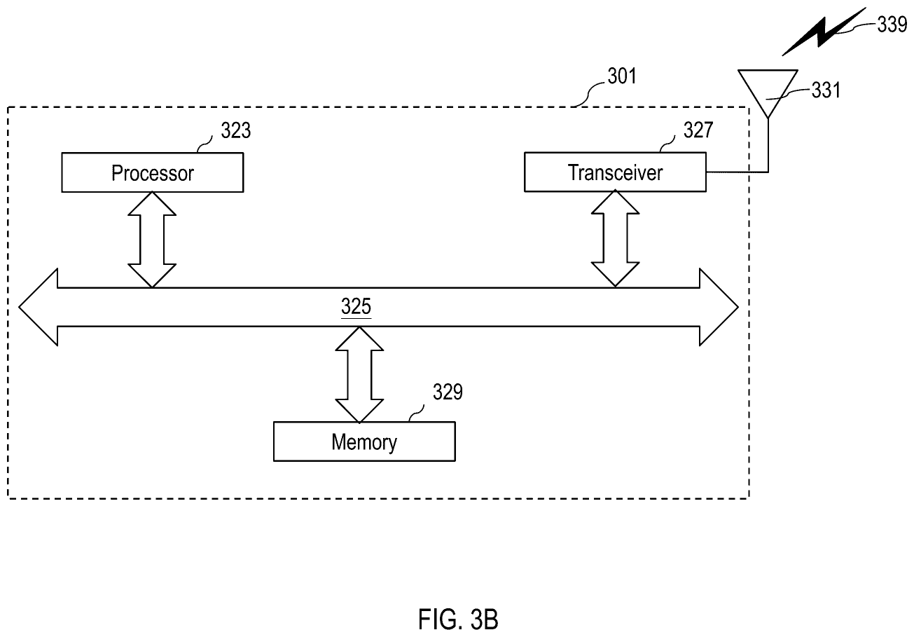

FIG. 3A shows a simplified block diagram of a tag 300 (e.g., user device) in an access system, according to some embodiments. FIG. 3B shows a simplified block diagram of an anchor 301 in the access system, according to some embodiments. Tag 300 may be an example of user device 108, anchor 301 may be an example of anchor 104, and the access system may be an example of access system 100. In some embodiments, the anchor 301 and tag 300 are wireless and connected to a local wireless network, which can be any wireless area network that allows devices to connect and communicate with each other wireless within a limited geographic area. For example, the local wireless network may be an automation network in a residential area, a hospital, a commercial building, a factory plant, a playground, a school, or the like. In various embodiments, the local wireless network may be built on one or more wireless communication protocols such as Wi-Fi, Bluetooth, near field communication (NFC), wireless local area network (LAN) Matter, Zigbee, IrDA, etc. It should be noted that, the number of anchors 301 and the number of tags 300 in an access system may vary, in different applications, and should not be limited by the embodiments of the present disclosure. For example, the access system may include more than one tags 300.

Tag 300 may be in the form of a mobile device capable of voice and/or data communication. Tag 300 may have built-in software and hardware that enable tag 300 to communicate with the network control device, anchor 301, and/or a cloud network via RF signals, e.g., UWB signals. In some embodiments, tag 300 is configured to communicate with anchor 301 via RF signals in UWB, WiFi, BLE, NFC, or the like. In some embodiments, tag 300 includes a UWB transceiver configured for ranging and/or data transfer. Tag 300 may include a cellular telephone, a smartphone, a laptop computer, a tablet, a personal digital assistant (PDA), a computing device, wearable devices (e.g., a smart watch, or the like), or any other mobile device having wireless connection capability. Although only a single tag 300 is shown in FIGS. 1A and 1B, one of ordinary skill in the art will appreciate that multiple tags may perform ranging with anchor 301 at the same time or at different times In some embodiments, tag 300 may communicate with anchor 301 via the network control device and/or the cloud network.

As shown in FIG. 3A, tag 300 may be in the form of a cellular telephone, a smartphone, a laptop computer, a tablet, a personal digital assistant (PDA), a computing device, or any other mobile device having wireless connection capability. In some embodiments, tag 300 includes a processor 303, a digital signal processor (DSP) 305, a transceiver 307, an antenna 317, a memory 309, an input device 311, an output device 313, and a bus 315. The hardware components of tag 300 may be communicatively coupled to bus 315. In some embodiments, bus 315 can be used for processor 303 to communicate between cores and/or with memory 309. Processor 303 may include one or more general-purpose processors and/or one or more special-purpose processors (such as digital signal processing chips, graphics acceleration processors, and/or the like). Processor 303 may process wireless signals 319 received by transceiver 307, such as ranging signals, and/or data from UWB communication. In some embodiments, processor 303 receives a UWB signal from anchor 301, generates a response with a timestamp, and transmits the response to anchor 301 in a TWR. Input device 311 may include a camera, a mouse, a keyboard, a touch sensitive screen/display, a touch pad, a keypad, and/or the like. An output device 313 may include a display, a printer, and/or the like. In some embodiments, tag 300 receives a status message from the access system that the entrance in the proximity of a user, carrying tag 300, is locked/unlocked. The status message may be displayed by output device 313. In some embodiments, a user, carrying tag 300, may load an access application, which automatically shows the lock/unlock of an entrance when the user is entering the entrance.

Tag 300 may include a transceiver 307 communicatively coupled to bus 315. Transceiver 307 may be operable to transmit and receive wireless signals 319 via antenna 317. Wireless signals 319 (e.g., UWB signals) may be transmitted/received via a wireless network (e.g., a local wireless network). In some embodiments, the wireless network may be any wireless network such as WiFi, a Personal Access Network (PAN), such as Matter, Bluetooth® or Zigbee®, or a cellular network (e.g., 4G, 5G). Transceiver 307 may be configured to receive wireless signals 319 via antenna 317 from a network control device, anchor 301, a cloud network, and/or the like. In some embodiments, transceiver 307 may receive the UWB signals in a ranging round between anchor 301. Tag 300 may also be configured to decode and/or decrypt, via the DSP 305 and/or processor 303, various signals received from the network control device, anchor 301, the cloud network, and/or the like.

Memory 309 may include one or more non-transitory storage devices that can include local and/or network accessible storage, a disk drive, a drive array, an optical storage device, a solid-state storage device such as a random access memory (“RAM”) and/or a read-only memory (“ROM”), a programmable ROM, a flash-updateable ROM, and/or the like. Such storage devices may be configured to implement any appropriate data storage, including without limitation, various file systems, database structures, and/or the like. In some embodiments, memory 309 includes a device database, including device information (e.g., unique device identification (ID), device keys, vendor information, device type, etc.) of tag 300 and/or one or more of anchor 301. In some embodiments, memory 309 is stored with location information of the anchors, e.g., 300. In some embodiments, memory 309 is stored with information from a ranging round, e.g., timestamps received from anchor 301.

In various embodiments, functions/operations may be stored as one or more instructions or code in memory 309, such as on a computer-readable storage medium, such as RAM, ROM, FLASH, or disc drive, and executed by processor 303 or DSP 305. Tag 300 may also include software components (e.g., located within memory 309), including, for example, an operating system, device drivers, executable libraries, and/or other executable code, such as one or more application programs. The application programs may include computer programs, stored in memory 309, executed by processor 303 and/or DSP 305 to implement various functions under the control of the operating system. The computer programs may have been pre-packaged with tag 300 or may have been downloaded by a user into memory 309 of tag 300. Some mobile applications may be more user-interactive applications, such as an access application show the locking/unlocking status of an entrance, whereas some other mobile applications may be less user-interactive in nature.

Anchor 301 may include a network device that allow the controller (e.g., an engineer or management) of the access system (e.g., 100/200) to access, control, and/or configure. Anchor 301 may be a fixed point or a reference location used to enhance the accuracy and stability of the access system. For example, anchor 301 may include beacons and/or access points placed in a designated area such as an entrance, e.g., covered by a local wireless network. Anchor 301 may have built-in software and hardware that enable itself to emit/blink radio frequency (RF) signals (e.g., UWB signals) that can be used to range with mobile devices (e.g., tag 300). In some embodiments, anchor 301 transmits RF signals in one or more wireless communication protocols such as UWB, WiFi, BLE, NFC, or the like. In some embodiments, anchor 301 may transmit device information, timestamps, and/or device status information (e.g., location information) to another anchor. In some embodiments, anchor 301 may transmit device information, timestamps, and/or device status information (e.g., location information) to a network control device and/or tag 300. In some embodiments, anchor 301 includes a UWB transceiver configured for ranging and/or data transfer.

As shown in FIG. 3B, anchor 301 may include a transceiver 327 and an antenna 331 (communicatively coupled to transceiver 327) for wireless communication with another anchor, tag 300, a cloud network, and/or a network control device. In some embodiments, anchor 301 also includes a processor 323, a memory 329, and a bus 325.

Transceiver 327 may be operable to transmit and receive wireless signals 339 via antenna 331. Wireless signals 339 (e.g., UWB signals) may be transmitted/received via a wireless network (e.g., a local wireless network). In some embodiments, the wireless network may be any wireless network such as WiFi, a Personal Access Network (PAN), such as Matter, Bluetooth® or Zigbee®, or a cellular network (e.g., 4G, 5G). Transceiver 327 may be configured to or receive wireless signals 339 via antenna 327 from a network control device, a tag (e.g., 301), another anchor, and/or the like. Optionally, anchor 301 may include a DSP (not show) for decoding and/or decrypting, various received signals 339.

In some embodiments, anchor 301 includes a processor 323 and a memory 329. Processor 323 may include one or more general-purpose processors and/or one or more special-purpose processors, similar to processor 303. In some embodiments, processor 323 may start ranging with tag 300 when tag is within a predetermined distance range (e.g., start-measure perimeter 113). In some embodiments, processor 323 may calculate UWB parameters such as a CIR estimate, the distance between tag 300 and anchor 301, the PDOA value of tag 300 relative to anchor 301, and/or the RSSI value from tag 300 at a given time. Processor 323 may generate a pair of CIR matrices, a distance vector, a PDOA vector, and a RSSI vector over a predetermined period of time, as the inputs to a deep learning framework. In some embodiments, processor 323 pre-process one or more of the inputs. Processor 323 may then compute the probabilities of three intent, e.g., enter, leave, and pass by, based on the inputs and a deep learning model. Processor 323 may also generate a determined intent of the user and generate a control signal corresponding to the determined intent, e.g., to lock/unlock the entrance.

Memory 329 may include one or more non-transitory storage devices, similar to memory 309. Bus 325 may communicatively couple processor 323, transceiver 327, and memory 329 such that processor 323 may execute instructions stored in memory 329 and may process signals 339 received by transceiver 327, such as ranging signal/data from UWB communication with tag 300. In some embodiments, memory 329 may be stored with timestamps of tag 300 for a TWR. In some embodiments, memory 329 may be stored with the deep learning framework, inputs of the deep learning framework, feature vectors, output of the deep learning framework, predetermined distance ranges for starting ranging with tag 300 and determining probabilities of intents, a predetermined threshold filter to determine a user's intent, etc.

In some embodiments, the access system includes a network control device communicatively coupled to anchor 301 and/or tag 300. The network control device may be configured to control the communication between anchor 301 and tag 300, and/or between anchor 301 (and/or tag 300) and an external network. The network control device may have its radio communication range formed in a radio communication scheme. The communication range may cover a perimeter such as a house, a commercial building, a hospital, a playground, etc. For instance, the network control device may communicate data and signals with anchor 301 located within the radio communication range such as a local wireless network using one or more radio communication schemes. The network control device may also be communicatively connected to a cloud network. In some embodiments, the network control device may use a wired communication protocol and/or wireless communication protocols. The network control device may acquire device information and device status information from anchor 301 located in the radio communication range and provide to the cloud network with the acquired information. The network control device may also provide the cloud network with network control device information and network control device status information. In some embodiments, the network control device has wireless communication functions, and may include, but not limited to, one or more of a gateway, a hub, a television, a router, a modem, a range extender, a set-top box, a smart speaker, a mobile device (e.g., tablet, mobile phone), and/or the like. For example, the network control device may include a gateway that allows data to flow from the local wireless network to the cloud network, or vice versa. In some embodiments, the network control device communicates using more than one internet protocol (IP) to connect the local wireless network and the cloud network. In various embodiments, the network control device communicates in wireless communication protocols such as Matter, Zigbee, Bluetooth (BLE), WiFi, IrDA, etc.

The network control device may provide tag 300 and anchor 301 with access to one or more external networks, such as the cloud network, the Internet, and/or other wide area networks. In some embodiments, the access system includes the cloud network. The cloud network may include a cloud infrastructure system that provides cloud services. In certain embodiments, services provided by the cloud network may include registration and access control of anchor 301 and tag 300. The cloud network may include one or more computers, servers, and/or systems. In some embodiments, the cloud network may include an application server that hosts an application, and a user may order and use the application via a communication link. In some embodiments, the communication link may include a UWB communication interface. In some embodiments, the communication link may also support other types of wireless connections, such as a Bluetooth communication interface, a Wi-Fi communication interface, a cellular network connection (e.g., 4G, 5G) interface, a near field communication (NFC) interface, a ZigBee communication interface, or a combination thereof.

In various embodiments, the deep learning framework can be stored in anchor 301, the network control device, and/or the cloud network. In some embodiments, the instructions/program codes to perform generating inputs for the deep learning model from the UWB data, calculating the intent probabilities, determining the intent, and generating the control signal based on the intent, can be partially or fully stored in one or more of anchor 300, the network control device, and cloud network. In various embodiments, the operations to determine a user's intent using UWB data can be partially or fully performed by one or more of anchor 301, the network control device, and the cloud network. In some embodiments, the entrance (e.g., 102) includes suitable software and/or hardware that are communicatively coupled to the access system such that the entrance may lock and/or unlock based on the received control signal, which is generated by the access system.

It should be noted that, in the present disclosure, at least one of the operations performed by access system 100/200 are implemented by a specialized hardware (such as an application-specific integrated circuit (ASIC) and/or a digital signal processor (DSP)), and/or or a general processor. The hardware may be installed locally in the anchor(s), in the network control device, and/or remotely in the cloud network.

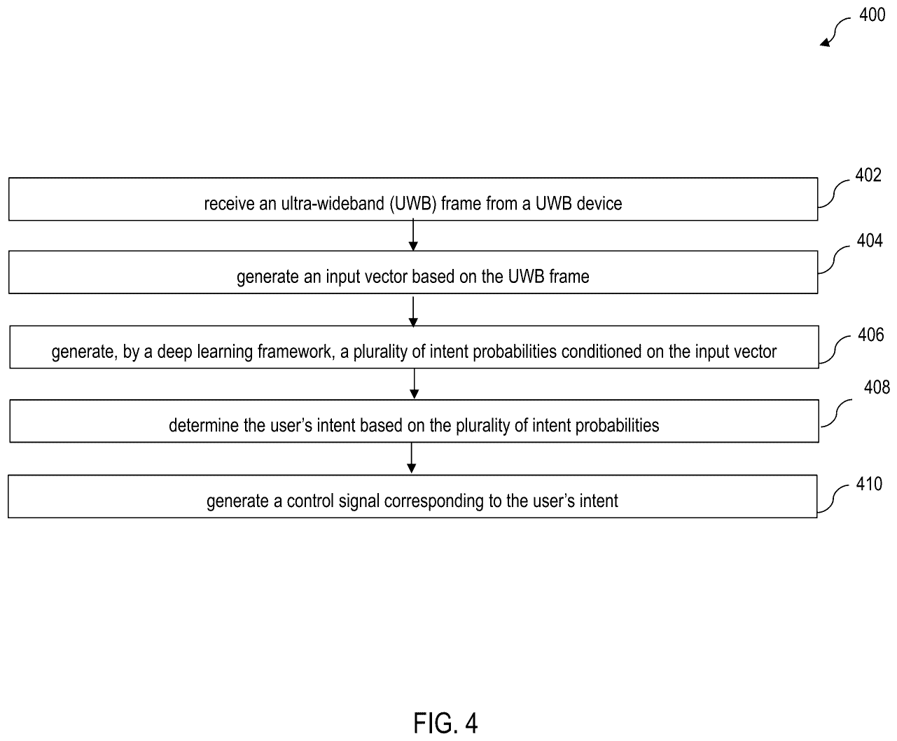

FIG. 4 is a flowchart of a method 400 for an access system 100/200 to control an object (e.g., an entrance) based on a determined user's intent, according to some embodiments of the present disclosure. In various embodiments, method 400 can be performed by an anchor, a network control device, and/or a cloud network, of the access system. Method 400 is merely an example, and is not intended to limit the present disclosure beyond what is explicitly recited in the claims. Additional operations can be provided before, during, and after the method 400, and some operations described can be replaced, eliminated, or moved around for additional embodiments of method 400. For ease of illustration, FIG. 4 is described in connection with FIGS. 1A, 1A, 2A, and 2B.

At step 402, an ultra-wideband (UWB) frame (e.g., 201) is received from a UWB device (e.g., 108).

At step 404, an input vector (e.g., 205, 202, 214, 220, and 226) is generated based on the UWB frame.

At step 406, a plurality of intent probabilities (e.g., 209) are generated by a deep learning framework (e.g., 207) conditioned on the input vector.

At step 408, the user's intent (e.g., 213) is determined based on the plurality of intent probabilities.

At step 410, a control signal (e.g., 217) is generated corresponding to the user's intent.

Those skilled in the art will recognize improvements and modifications to the preferred embodiments of the present disclosure. All such improvements and modifications are considered within the scope of the concepts disclosed herein and the claims that follow.

What is claimed is:

1. A method for controlling an object based on a user's intent, comprising:
receiving an ultra-wideband (UWB) frame from a UWB device;
generating an input vector based on the UWB frame;
generating, by a deep learning framework, a plurality of intent probabilities conditioned on the input vector;
determining the user's intent based on the plurality of intent probabilities; and
generating a control signal corresponding to the user's intent.

2. The method of claim 1, wherein the generating of the input vector comprises generating a first input vector and a second input vector, each corresponding to a different type of UWB data.

3. The method of claim 2, wherein the generating, by the deep learning framework, the plurality of intent probabilities conditioned on the input vector comprises:
generating, by the deep learning framework, a first feature vector from the first input vector and a second feature vector from the second input vector;
performing, by the deep learning framework, a feature fusion operation to generate a concatenated feature vector combining the first feature vector and the second feature vector; and
generating, by the deep learning framework, the plurality of intent probabilities based on the concatenated feature vector.

4. The method of claim 3, wherein:
the deep learning framework comprises a first deep learning model to generate the first feature vector and a second deep learning model to generate the second feature vector; and
the deep learning framework comprises a fully connected layer and a SoftMax layer to generate the plurality of intent probabilities from the concatenated feature vector.

5. The method of claim 1, wherein the determining of the user's intent comprises comparing the plurality of intent probabilities to a threshold value;
in response to a highest one of the intent probabilities being higher than or equal to the threshold, determining the user's intent to be a predetermined classification; and
in response to the highest one of the intent probabilities being lower than the threshold, determining the user's intent to be “unknown.”

6. The method of claim 3, wherein the generating of the first input vector comprises:
determining a plurality of channel impulse response (CIR) estimates based on the UWB frame that is transmitted by a UWB radar and reflected by the user and a surrounding environment;
selecting a plurality of taps from each of the plurality of CIR estimates; and
generating a CIR vector based on the plurality of CIR estimates and the plurality of taps corresponding to each of the plurality of CIR estimates.

7. The method of claim 6, further comprising dividing the CIR vector into a first CIR vector and a second CIR vector, wherein the first CIR vector comprises a real component of the CIR vector and the second CIR vector comprises an imaginary component of the CIR vector.

8. The method of claim 7, further comprising applying a pre-processing algorithm on the first CIR vector or the second CIR vector, wherein the pre-processing algorithm comprises a Clutter Cancellation algorithm, a constant false alarm rate (CFAR) filtering algorithm, or an Image Reshape algorithm.

9. The method of claim 6, wherein the deep learning framework comprises a convolutional neural network (CNN), gated recurrent units (GRUs), or long short-term memory (LSTM) cells, or a fully connected (FC) layer to generate the first feature vector.

10. The method of claim 3, further comprising initiating a two-way ranging (TWR) with the UWB device, and wherein the generating of the second input vector further comprises:
measuring a plurality of UWB values from a plurality of ranging rounds in the TWR; and
generating the second input vector comprising the plurality of consecutive UWB values.

11. The method of claim 10, wherein in response to a measuring of a UWB value in a first ranging round being unsuccessful, replacing the UWB value in the input vector with a UWB value that is successfully measured in a second ranging round that is most recent to the first ranging round.

12. The method of claim 10, wherein the generating of the second input vector comprises generating a distance vector comprising a plurality of distance estimates computed from the plurality of ranging rounds.

13. The method of claim 10, wherein the generating of the second input vector comprises generating a set of phase difference of arrival (PDOA) vectors computed from the plurality of ranging rounds, the sets of the PDOA vectors comprising a plurality of PDOA estimates computed from each of the ranging rounds.

14. The method of claim 10, wherein the generating of the second input vector further comprises generating a received signal strength indicator (RSSI) vector comprising a plurality of RSSI estimates computed from the plurality of ranging rounds.

15. The method of claim 10, wherein the deep learning framework comprises gated recurrent units (GRUs) to generate the second feature vector.

16. An ultra-wideband (UWB) device, comprising a UWB receiver configured to:
receive an ultra-wideband (UWB) frame from a UWB device;
generate an input vector based on the UWB frame;
generate, by a deep learning framework, a plurality of intent probabilities conditioned on the input vector;
determine the user's intent based on the plurality of intent probabilities; and
generate a control signal corresponding to a user's intent.

17. The UWB device of claim 16, wherein:
to generate the input vector comprises generating a first input vector and a second input vector, each corresponding to a different type of UWB data; and
the first input vector and the second input vector include UWB parameters measured at a same rate during a same period of time.

18. The UWB device of claim 17, wherein to generate, by the deep learning framework, the plurality of intent probabilities conditioned on the input vector comprises:
generating, by the deep learning framework, a first feature vector from the first input vector and a second feature vector from the second input vector;
performing, by the deep learning framework, a feature fusion operation to generate a concatenated feature vector combining the first feature vector and the second feature vector; and
generating, by the deep learning framework, the plurality of intent probabilities based on the concatenated feature vector.

19. The UWB device of claim 18, wherein:
the deep learning framework comprises a first deep learning model to generate the first feature vector and a second deep learning model to generate the second feature vector; and
the deep learning framework comprises a fully connected layer and a SoftMax layer to generate the plurality of intent probabilities from the concatenated feature vector.

20. A non-transitory computer-readable medium (CRM) having program code recorded thereon, the program code comprising:
code for receiving an ultra-wideband (UWB) frame from a UWB device;
code for generating an input vector based on the UWB frame;
code for generating, by a deep learning framework, a plurality of intent probabilities conditioned on the input vector;
code for determining the user's intent based on the plurality of intent probabilities; and
code for generating a control signal corresponding to a user's intent.
